(19) United States
(12) Patent Application Publication
(10) Pub. No.: US 2016/0288453 A1
(43) Pub. Date: Oct. 6, 2016

(54) Composite Material

(71) Applicant: L'GARDE INC., Tustin, CA (US)

(72) Inventor: Juan M. Mejia-Ariza, Santa Ana, CA (US)

(73) Assignee: L'GARDE INC., Tustin, CA (US)

(21) Appl. No.: 15/035,159

(22) PCT Filed: Nov. 6, 2014
(86) PCT No.: PCT/US14/64448

§ 371 Date: May 6, 2016

Related U.S. Application Data
(60) Provisional application No. 61/900,882, filed on Nov. 6, 2013.

(51) Int. Cl. B32B 5/12; B29C 70/20; B32B 25/20; B32B 7/02; B32B 5/02; B32B 25/02

(52) U.S. Cl. CPC B32B 5/12; B32B 5/024; B32B 25/02; B32B 25/20; B32B 7/02; B29C 70/207; B32B 2262/106; B32B 2307/51; B32B 2307/54; B32B 2307/536; B32B 2307/30; B29K 2083/00

(57) ABSTRACT

A unidirectional elastomeric composite comprises a plurality of fibers generally aligned in a first direction with an elastomer filling the space between fibers. The plurality of fibers may comprise an intermediate modulus carbon fiber. Preferably, the plurality of fibers have an ultimate elongation at failure or tensile failure strain of 1% or greater, a tensile modulus between 200-400 GPa and tensile strength greater than 4 GPa. The resin or matrix may be a passive elastomer that will maintain its mechanical and chemical properties at a specific operational temperature range. Elastomers are polymers with viscoelasticity, generally having low Young's modulus and high failure strain. Methods of manufacturing the unidirectional elastomeric composite include apply the resin to fibers maintained in tension to maintain the fiber alignment.

### CROSS REFERENCE TO RELATED APPLICATIONS

This application claims priority to U.S. Provisional Application 61/900,882, filed Nov. 6, 2013, and titled “Flexible Lightweight Adjustable Stiffness Hinge (FLASH),” which is incorporated by reference in its entirety herein.

### BACKGROUND

Deployable structures are generally those that can reduce or increase their original volume by packaging or deploying into a smaller volume, respectively. Different material and mechanical structures are used in deployable structures.

For example, rigid mechanical connections allow different kinematic degrees of freedom between rigid connected parts. Compliant joints and mechanisms generally use flexible materials to deform to a desired configuration. However, rigid connections are generally more complex in construction, which results in higher manufacturing costs. Rigid connections may also be subject to higher wear, and lower accuracy and repeatability. Moreover, the components generally include dissimilar materials resulting in different coefficients of thermal expansion, high density, and higher weight.

Rigid mechanical connections include, for example, hinges, sliders, universal joints, and ball-and-socket joints that allow different kinematic degrees of freedom between connected parts. These are the building blocks of most of the mechanisms used in manufacturing, robotics, and automobiles, etc. However, the clearance between mating parts of rigid joints causes backlash in mechanical assemblies such as the exemplary pin joint 2 in FIG. 1. FIG. 1 illustrates an exemplary rigid mechanical connection in which two rigid structures 4, 6 are coupled by a pin 8. As illustrated, the components come together at a friction point 3 and leave a backlash gap 5. Further, in all the above joints, there is relative motion causing friction that leads to wear and increased clearances. A kinematic chain of such joints compounds the individual errors from backlash and wear, resulting in poor accuracy and repeatability.

Compliant structures provide alternate solutions for transferring or transforming motion, force, or energy. Unlike rigid-link mechanisms, compliant mechanisms rely on the deflection of flexible members for device mobility rather than from movable joints only. Input force is transferred to output motion and some energy is stored in the form of strain energy in the flexible members. However, compliant structures generally do not provide sufficient rigidity, are not sufficiently thermally stable, or only have narrow ranges of operational temperatures.

Compliant joints such as flexures, couplings, flexure pivots, flex connectors, living hinges, and flexible joints offer an alternative to traditional mechanical joints that alleviates many of their disadvantages. However, in many applications today, such as eyewear, robots, scissors, toys, prostheses, etc., rigid-body mechanisms are still used because the resulting compliant materials lack the right balance of mechanical properties. For instance, polymers such as plastics and elastomers are used mainly in compliant mechanisms that require large deformations and tight stowed radius. Although they have low density and large strain in bending, the limitations of such materials are that they are not sufficiently stiff, not thermally stable, and only have narrow operational temperature ranges.

Actuated composites attempt to bridge the gap between the rigid mechanical connections and those of compliant structures by changing the material stiffness as a function of temperature. However, such materials require controlled temperatures for stowing and deploying. The added devices to heat and/or cool the material to the necessary temperatures add system complexity, weight, and cost to actuate the deployable structure.

Actuated composites can change their stiffness as a function of temperature. This change in stiffness allows the actuated composite to be soft in the packaged state to avoid composite failure, and be rigid in the deployable state to meet performance requirements. The main limitation of this kind of actuated composite is that the temperature needs to be precisely monitored and tailored in a controllable environment in order to properly activate the actuated composite. This means that an external energy source and additional equipment is needed that will not only add cost and mass, but could introduce geometric imperfections such as straightness imperfections due to thermal effects. These imperfections can degrade axial stiffness and therefore bending stiffness in structures. Accordingly, active hinges add weight and complexity to any structure.

An exemplary smart material is super-elastic Nickel-Titanium shape memory alloy. This alloy has almost five times the density of elastomeric composites, and its operational temperature range goes only from body to room temperature. Also, it only can generate a strain close to 5%. Another exemplary actuated composite includes the rigidizable space resin (L6) that has a low modulus (10.6 MPa, 1.5 kpsi) at room temperature, but can reach a modulus similar to epoxy resins (1.68 GPa, 243 kpsi) at a low temperature, −100 C.

In addition, in spite of the various technology advances in the area of lightweight deployable structures during the last ten years, a decrease in material density continues to be the most important and challenging parameter in achieving increased performance and functionality. However, current large systems are also limited by stowed volume. In order to develop a revolutionary advancement in the area of lightweight structures, better lightweight and passive composites with better material metrics and properties that are independent of temperature are desired.

### BRIEF SUMMARY

Embodiments described herein include a flexible, lightweight, composite material that can be used as a deployable structure having a low stowed volume, but still meet structural requirements.

Embodiments as described herein comprise elastomeric composites in which a plurality of fibers are combined with an elastomer. The fibers may be generally aligned, thus creating a unidirectional elastomeric composite. The fiber volume fraction between 20-50% is preferred, but typical values of 45-65% are possible as well. The fiber volume fraction is the fraction of the composite volume comprising fibers compared to the entire volume of the composite, including fibers and elastomer. The resulting density of the composite may be between 600-2000 kg/m³, less than 1500 kg/m³, or less than approximately 1350 kg/m³. Embodiments of the elastomeric composites as described herein can develop a large effective compressive strain at bending (20-60%, preferably over 30%, or 30%-50%) and a compressive critical stress of 5-500 MPa.

The uniformity and straightness of the fibers may be improved to control the compressive modulus and critical compressive stress of the composite. The initial tensile modulus in the deployed state of the composites (when fibers are generally straight) may be between 30-150 GPa, while the initial compressive modulus could be half the tensile modulus or higher depending on how straight the fibers are. Exemplary material configurations provide an inter-laminar shear strain development close to 120-160%. Material thickness ranging from 0.1 mm to 10 mm can have an exemplary minimum stowed radius under 50 mm and a minimum stowed radius close to 1 mm may be achieved.

There are several ways to control the minimum allowed stowed radius by adding very thin layers of kapton or Mylar in the two or one surface(s) of the material. Also, in the surface that will be outside in tension, woven carbon fabric can be added at +45/−45, +30/−30 or +60/−60 degrees to the interior fibers or 0 or 90 degrees to the unidirectional fibers, or any quasi-isotropic configuration. Many other different configurations are possible to control the minimum radius such as the use of Kevlar, fiberglass or Vectran fibers in many orientations and in different layers. The configuration, composition, and amount of layers may also be selected or substituted to create a composite of having the desired characteristics. Increasing the thickness of the composite material may also be used to help control the stowed radius.

Exemplary composite materials described herein are perfect for structural light-weighting applications. Exemplary composites described herein may have a passive deployment mechanism that allows carbon fibers to micro-buckle out-of-plane, preventing them from breaking when the composite is folded. The elastic micro-buckling behavior is present in composite materials described herein without the need of applying low tensile forces in the composite at the same time the material is bended. This phenomenon is what allows the composite material to store a little amount of elastic energy during folding. In the deployment process, the elastic energy is released enabling the material to unfold back to its original deployed shape. Typical unidirectional hard composites will have instead a plastic micro-buckling failure or kinking because the hard resin constrains the carbon fibers by preventing them from accommodating out-of plane buckling.

Exemplary fibers used herein may have ultimate elongation at failure or tensile failure strain of 1% or greater. At the same time, exemplary samples may have tensile modulus between 200-400 GPa and tensile strength greater than 4 GPa. FIG. 9 is a table that shows exemplary fibers for use herein.

In an exemplary embodiment, the resin or matrix filling the spaces between the fibers is a passive elastomer that will maintain its mechanical and chemical properties at a specific operational temperature range. Elastomers are polymers with viscoelasticity, generally having low Young's modulus and high failure strain compared with traditional materials such as metals, ceramics, and even epoxies and many plastics. In specific examples, after deformation, they can return to their original shape. These kinds of resins may be a thermoset or thermoplastic, but the most typical ones are thermosets such as silicones and polyurethanes. Some silicones are ideal for space applications because they have the highest operational temperature range compared with other elastomers (high and low temperatures, from −150° C. to 200° C.). Preferably, the resin has approximately 25-55 shore A durometer or hardness that corresponds to a Young's Modulus of 0.5-5 MPa. The best performance can be accomplished with modulus of 1-2 MPa. Some examples of elastomers are listed in FIG. 10 that meet the preferred resin requirements. Also, the resins can have elongation at break greater than 100%, tensile strength greater than 300 psi, and viscosity lower than 100,000 cP for easy impregnation.

### DRAWINGS

FIG. 1 illustrates an exemplary conventional pin joint;

FIG. 2 illustrates an exemplary composite structure according to embodiments described herein;

FIG. 3 illustrates an exemplary composite structure according to embodiments described herein;

FIG. 4 illustrates an exemplary composite structure according to embodiments described herein;

FIG. 5 illustrates an exemplary composite structure according to embodiments described herein;

FIG. 6 illustrates an exemplary graph of an effective compressive modulus as a function of effective compressive strain at bending for an exemplary composite structure according to embodiments described herein;

FIG. 7 illustrates an exemplary graph of an effective compressive modulus as a function of stowed radius at bending for an exemplary composite structure according to embodiments described herein;

FIG. 8A-8E illustrate exemplary micro-buckling of fibers within the composite structure during bending, FIG. 8A is a composite in a packaged state, FIG. 8B illustrates a close up of the out of lane micro-buckling, FIG. 8C is a composite in a deployed state, FIG. 8D is a line drawing of the bending of the FIG. 8E composite with associated bending functions and descriptions;

FIG. 9 is an exemplary table of material properties of different kinds of exemplary commercial fibers for use in exemplary elastomeric composites described herein;

FIG. 10 is an exemplary table of selected resins for use in exemplary elastomeric composites described herein;

FIG. 11 is an exemplary table of folding failure strain and modulus comparison between approximated solutions and experimental results in which the material has the following characteristics: k=0.9/mm, V_{f}=35%, and t=0.54 mm; IM7F: k=0.339/mm, V_{f}=63%, and t=0.127 mm; others: k=0.8/mm, V_{f}=40%, and t=0.386 mm;

FIG. 12 illustrates an exemplary curvature measurement for thin composites in which FIG. 12A has material characteristics of k=0.399/mm IM7F with V_{f}=63% and t=0.127 mm, and FIG. 12B has material characteristics of k=0.900/mm LGHM with V_{f}=35%, and t=0.54 mm.

FIG. 13 is an exemplary table of material properties of different kinds of exemplary medium modulus materials for use with embodiments described herein;

FIG. 14 illustrates packaging radius for materials listing in FIG. 13, in which LGHM is shown as the optimal composite for short flexure hinges;

FIGS. 15A-15D illustrates an exemplary folding sequence of a composite lamina according to embodiments described herein in a Miura-origami pattern;

FIG. 16 is an exemplary table of material properties of different kinds of materials conventionally used for lightweight space structures;

FIG. 17 illustrates an exemplary graph of material performance for lightweight structures;

FIG. 18 illustrates an exemplary rolling or packaging approach to storing composite materials described herein;

FIG. 19 is an exemplary table of material properties and parameters of unidirectional elastomeric composites with composites with t=0.386 mm (except IM7F has t=0.127 mm and LGHM has t=0.54 mm); the silicone modulus is 0.916 MPa, and the 8552 epoxy modulus is 4.67 GPa;

FIG. 20 illustrates an exemplary graph of the distributed strain material performance, in which elastomeric composites according to embodiments described herein are in the upper right portion with higher material metrics compared with traditional materials (IM10/s and AS4/s are conceptual composites made of carbon fibers and silicone in which the V_{f}=40% and t=0.386 mm, and the lower case c denotes the material in compression, and lower case t denotes the material in tension);

FIG. 21 illustrates exemplary truss performance metrics for trusses of thin-walled tubes using LGHMc;

FIG. 22 illustrates an exemplary graph of concentrated strain material performance with V_{f}=40% and t=0.386 mm for the elastomeric composites (except LGHM has V_{f}=35% and t=0.54 mm) in which the elastomeric composites according to embodiments described herein are on the right of the graph with better material metrics;

FIG. 23 illustrates an exemplary coilable longer mast (ATK-Able Graphite Coilable) using the distributed strain approach;

FIGS. 24A-24H illustrate exemplary elastomeric composite booms using silicone according to embodiments described herein, in which FIGS. 24A-24G illustrate exemplary elastomeric shape-memory carbon composite booms from free shape to rolled then from rolled to free shape, and FIG. 24H illustrates an exemplary 8 inch diameter boom made of a rigidizable carbon composite;

FIG. 25A-25C illustrates exemplary elastomeric composite booms using urethane according to embodiments described herein in which boom 1 has a diameter of approximately 1.5 inches, length of 38.38 inches, thickness of 0.015 inches and weight of 0.105 pounds-force, and boom 2 has a diameter of approximately 0.5 inches, length of 27.25 inches, thickness of 0.008 inches, and weight of approximately 0.015 pounds-force, the first tube is folded with a side length of 2 inches to result in a stowed length of 1.6 inches, and the second tube is folded with a side length of 0.8 inches to result in a stowed length of 0.9 inches;

FIG. 26 illustrates an exemplary eyeglasses including various components of the frames labeled that may incorporate composite material as described herein; and

FIG. 27 illustrates an exemplary method of manufacturing unidirectional elastomeric composites as described herein.

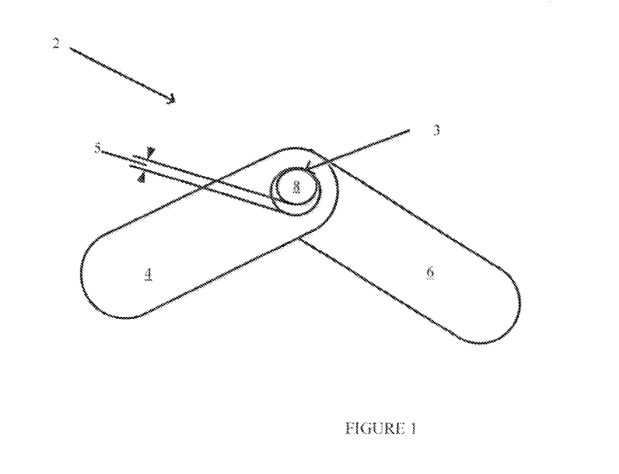

### DETAILED DESCRIPTION

The following detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention. It should be understood that the drawings are diagrammatic and schematic representations of exemplary embodiments of the invention, and are not limiting of the present invention nor are they necessarily drawn to scale.

Embodiments of the composite structures described herein may include properties that can increase reliability and structural performance while reducing the mass and complexity of a system. For example, desired properties may include low coefficients of thermal expansion and low density, while maintaining sufficient structural stiffness or rigidity.

Although embodiments of the invention may be described and illustrated herein in terms of rods or sheets of composite materials, it should be understood that embodiments of this invention are not so limited, but are additionally applicable to other material configurations having different cross-sections or surface configurations. Furthermore, although embodiments of the invention may be described and illustrated herein in terms of exemplary applications, it should be understood that embodiments of the invention are also applicable to other applications benefiting from the described material properties.

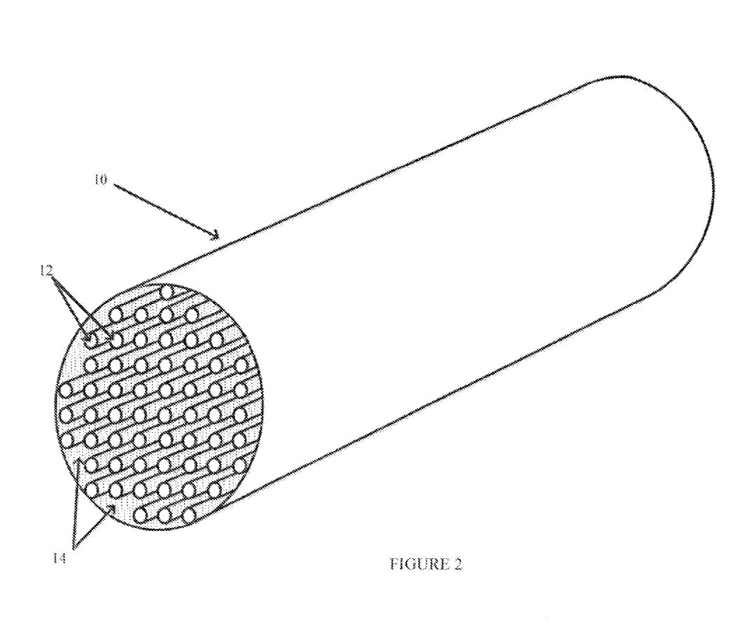

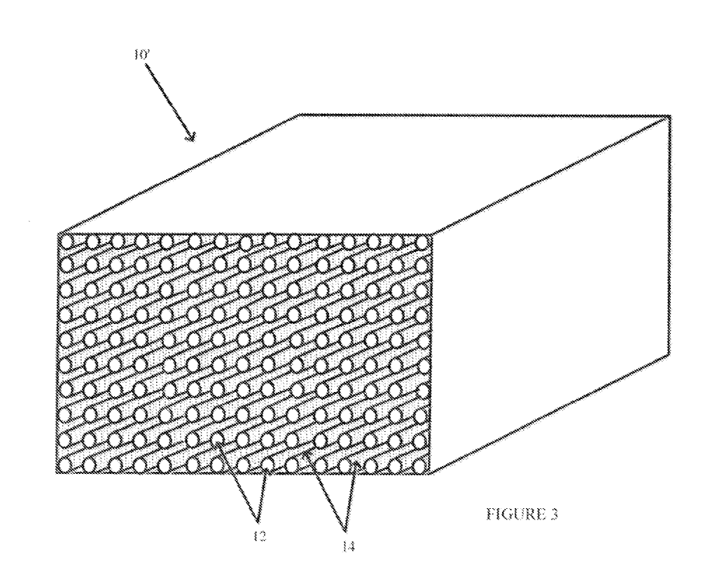

FIGS. 2 and 3 illustrate exemplary composites according to embodiments described herein. An exemplary composite 10, 10′ comprises a plurality of fibers 12 and a resin 14. The fibers 12 are illustrated as separated for the sake of illustration but may be separated or in contact with adjacent fibers. The resin 14 fills the open spaces between the fibers 12. The fibers are illustrated with a circular, uniform cross section along their length, but any cross-section or variability of cross-section along the fiber length or across the composite cross section may be included to achieve different material responses. As shown, the exemplary composite is in a generally uniform cross-section along its length. FIG. 2 illustrates an exemplary circular cross-section, while FIG. 3 illustrates a generally rectangular cross section. Different cross-sections and variable cross-sections are contemplated and included within the disclosure of the present disclosure. For example, the composite material may be formed into a rod, cable, cord, or other elongated structure, or as a sheet by altering the dimensions of the composite structure.

As illustrated, the fibers 12 are aligned along the longitudinal axis of the fiber. In an exemplary embodiment, the fibers are generally parallel. “Generally” as used herein with respect to aligned or configuration is intended to include some deviation away from perfect alignment. However, in general, the fibers are facing along the same direction, such that the terminal ends of one end of the fibers are at one end or side of the composite material and terminal ends of the other opposing end of the fibers are at another end or side of the composite structure. The more alignment between the respective fibers, generally the better control over the respective material properties. However, there is a tradeoff in aligning fibers during manufacturing and the cost to create the material. Therefore, perfect alignment is desired, but not necessary by the present disclosure. The tolerances would be understood to a person of skill in the art as deviations or errors inherent in the manufacturing processes selected. The fibers 12 are preferably generally aligned in an unstressed state. For example, the fibers may be straight and parallel along the length of the fiber.

The fibers may also be aligned in one or more directions in a plane transverse to the longitudinal axis of the fibers. For example, the fibers 12 may be generally layered such that they align with a lateral edge of a sheet. Thus, all of the fibers are generally aligned. In another example, a first plurality of fibers may be aligned in a first plane, and a second plurality of fibers may be aligned in a second plane. The first and second planes may be adjacent, aligned, parallel, or combinations thereof. In an exemplary embodiment, the second plane may be an exterior lateral edge of the composite structure. In an exemplary embodiment, the fibers 12 may be formed in aligned rows as illustrated. Alternatively, or in addition thereto, the fibers 12 may be aligned in a second direction in a lateral plane. In an exemplary embodiment, fibers may be aligned along generally parallel planes oriented parallel to the longitudinal axis of the fibers. The fibers within the planes may be variably spaced or uniformly spaced.

The term plane is used herein to describe the orientation of the fibers. Plane is not intended to be limited to a two dimensional construct. Because the fibers have depth, when they are aligned in a plane, they are generally aligned along the same two dimensional axis. However, because of the depth of the fibers and the possible variability of diameter of fibers, a plane is intended to encompass some depth component such that if the fibers overlap as seen from a direction perpendicular to the described alignment plane, then the fibers are considered to be in the same plane. In other words, if any cross sectional portion of the fiber is contained within a two-dimensional plane along the fiber's length, then the fibers are considered to be aligned in that plane. For example, if a single row of fibers were used and positioned on a level, flat surface, such as a table top, the fibers would be considered to align regardless of their diameter or cross sectional dimensions because at least the lower point of the fibers are all in the plane contacting the table top. Some error is permitted for the inclusion of the length of the fiber within the plane that would be understood by a person of skill in the art according to the manufacturing selection and composite requirements. For example, if the fiber's cross section is contained in a plane for more than 90% of the length of the fiber and the remaining 10% does not deviate perpendicularly away from the plane by more than 1-2× the diameter of the fiber, then the entire fiber is considered aligned within the plane.

In an exemplary embodiment, a first plurality of fibers are aligned in a first direction throughout the interior of the composite material. A second plurality of fibers on an exterior surface of the composite structure are aligned in a second direction different from the first direction. In an exemplary embodiment, the second direction is oblique to the first direction. The longitudinal axis of the second plurality of fibers may be generally oblique to the longitudinal axis of the first plurality of fibers. In an exemplary embodiment, the axes are between 20 and 70 degrees; for example, the angles may be approximately 45 degrees, 30 degrees, or 70 degrees.

In an exemplary embodiment, a third plurality of fibers may be aligned in a third direction. The third plurality of fibers may be between the first and second plurality of fibers, thus creating an intermediate layer between the interior composite material created by the first plurality of fibers and the exterior surface defined by the second plurality of fibers. The third plurality of fibers may be aligned generally perpendicular with the second plurality of fibers. The third plurality of fibers may be oblique to the longitudinal axis of the first plurality of fibers. For example, the third plurality of fibers may be between +/−20 and +/−70 degrees; for example the angles may be approximately −45 degrees, −30 degrees, or −70 degrees.

In an exemplary embodiment the second and third plurality of fibers may be generally the same layer. For example, the second and third plurality of fibers may be woven. Alternatively, the second and third layers may be adjacent, separate layers such that the second layer is an exterior layer and the third layer is between the interior, first layer and the exterior second layer. The first and second layer may be in direct contact, without the third layer. The third layer may be in direct contact with both the first and second layer.

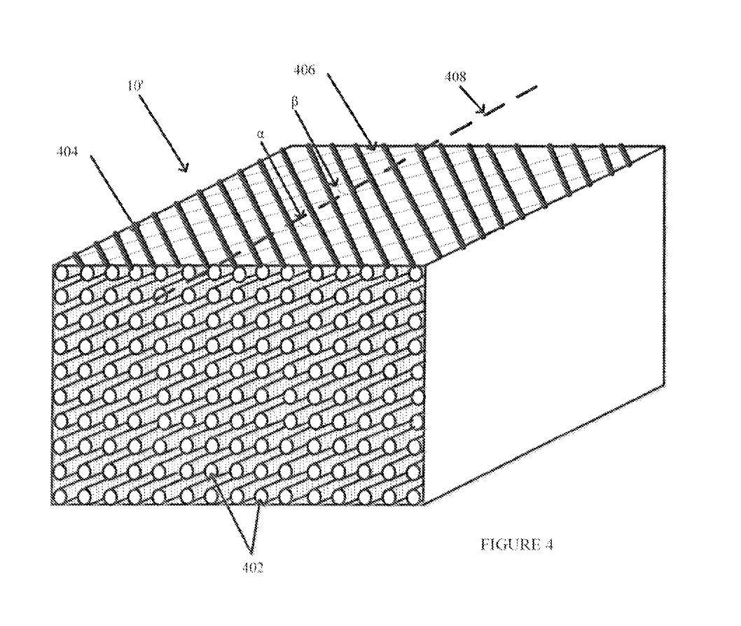

In an exemplary sheet embodiment shown in FIG. 4, similar to that illustrated in FIG. 3, the first plurality of fibers 402, second plurality of fibers 404, and third plurality of fibers 406 may be contained in respective planar layers. The first and second plurality of fibers may occur on a single side of the first plurality of fibers, or may be mirrored or positioned on one or more exterior surfaces of the composite material. As shown, the second plurality of fibers 404 are angled (α) with respect to a line parallel to the axis of the first plurality of fibers, and the third plurality of fibers 406 are angled (β) with respect to that same line. The angles may be between +/−20 and +/−70 degrees. The magnitude of the angles may be the same or different. The angles may opposite, or mirrored around the measurement axis 408.

In an exemplary rod or cable embodiment, as shown in FIG. 5, similar to that illustrated in FIG. 2, the first layer 502 may be an interior portion of the rod in a generally cylindrical configuration. The second plurality of fibers 504 may be an exterior surface circumferentially surrounding the first plurality of fibers or may be around a portion of the perimeter defined by the first plurality of fibers. In an exemplary embodiment, the second and/or third plurality of fibers 506 may be generally helical around the first plurality of fibers. As shown, the second plurality of fibers 504 are angled (α) with respect to a line parallel to the axis of the first plurality of fibers, and the third plurality of fibers 506 are angled (β) with respect to that same line. The angles may be between +/−20 and +/−70 degrees. The second and/or third plurality of fibers may also be configured such that a portion of a sheet was wrapped around all or a portion of the first plurality of fibers. Therefore, multiple, discontinuous fiber portions may be positioned along the length of the first plurality of fibers, and may either fully or partially circumscribe the outer perimeter of the first plurality of fibers.

In an exemplary embodiment, the composite material comprises a plurality of fibers generally aligned throughout its volume, with a resin completely filling the space between the plurality of fibers. If the use is oriented such that one exterior surface or side is in tension, a woven fabric can be added to the exterior surface with fibers at an angle of +45/−45, +30/−30 or +60/−60. Alternatively, woven carbon fabric of 0 or 90 degrees, or uni-directional fibers, or any quasi-isotropic configuration, may be used.

Another exemplary way to control the stowed radius of the composite material can be achieved by increasing the stiffness of the resin, and/or the fiber volume fraction as a function of thickness. When bending the proposed composite, the fibers in most of the layers will buckle and store strain energy as the neutral axis shifts closer to the outer surface layer. Since the closer the fibers are to the inner layer, the more they buckle, a lower stiffness elastomer and also a lower fiber volume fraction may therefore be present. Furthermore, the opposite may occur with the fibers that are closer to the outer surface layer. These are in tension and therefore a very high stiffness resin and high volume fiber fraction may be used.

Embodiments as described herein comprise elastomeric composites in which a plurality of fibers are combined with an elastomer. The fibers may be generally aligned, thus creating a unidirectional elastomeric composite. The fiber volume fraction between 20-70% is preferred, but typical values of 45-65% are possible as well. The resulting density of the composite may be between 600-2000 kg/m³, less than 1500 kg/m³, or less than approximately 1350 kg/m³. Embodiments of the elastomeric composites as described herein can develop a large effective compressive strain at bending (20-60%, preferably over 30%, or 30%-50%) and a compressive critical stress of 5-500 MPa. The uniformity and straightness of the fibers may be improved to control the compressive modulus and critical compressive stress of the composite. The initial tensile modulus in the deployed state of the composites (when fibers are straight) are between 30-150 GPa, while the initial compressive modulus could be half the tensile modulus or higher depending on how straight the fibers are. This material configuration provides an inter-laminar shear strain development close to 120-160%. Material thickness range is 0.1-10 mm and minimum stowed radius under 50 mm and close to 1mm can be achieved. There are several ways to control the minimum allowed stowed radius by adding very thin layers of kapton or Mylar in the two or one surface(s) of the material. Also, in the surface that will be outside in tension, woven carbon fabric can be added at +45/−45, +30/−30 or +60/−60 degrees to the interior fibers or 0 or 90 degrees to the unidirectional fibers, or any quasi-isotropic configuration. Many other different configurations are possible to control the minimum radius. For example, Kevlar, fiberglass or Vectran fibers may be used in many orientations and in different layers. Increasing the thickness of the composite material may also be used to help control the stowed radius.

The elastomeric composites described herein balance effective compressive stiffness and effective compressive strain at bending, and therefore, do not need any external energy source or equipment to be deployed as is required by actuated composites. The disclosed composite materials are made of passive unidirectional elastomeric composites that have variable compressive stiffness and variable compressive strain in bending as shown on FIG. 6. Therefore, the compressive effective modulus can go from 30-150 GPa in the deployed state to 5 MPa in the packaged state. The corresponding plot that provides the effective compressive stiffness as a function of stowed radius is given by FIG. 7. The minimum radius that the invention can accomplish is as low as 1mm due to a reduction of the effective compressive stiffness at bending.

Thus, exemplary composite materials described herein are perfect for structural light-weighting applications. Exemplary composites described herein may have a passive deployment mechanism that allows carbon fibers to micro-buckle out-of-plane, preventing them from breaking when the composite is folded as shown in FIG. 6. The elastic micro-buckling behavior is present in composite materials described herein without the need of applying low tensile forces in the composite at the same time the material is bended. This phenomenon is what allows the composite material to store a little amount of elastic energy during folding. In the deployment process, the elastic energy is released enabling the material to unfold back to its original deployed shape. Typical unidirectional hard composites will have instead a plastic micro-buckling failure or kinking because the hard resin constrains the carbon fibers by preventing them from accommodating out-of plane buckling. On the other hand, very thin hard composites (0.125-0.4 mm) will be able to obtain the elastic micro-buckling phenomenon if sufficient tension is applied to the composite at the same time the material is bent. Another example of a material that needs to have tension when bending to avoid failure is actuated composite made of L•Garde L6 smart (rigidizable) resin at room temperature. L6 at room temperature has a modulus close to ˜10 MPa and that it is higher than the maximum ideal modulus for the FLASH application. The same happens with other smart resins used in the industry such as shape memory polymer (SMP) in combination with fiber reinforcement to form Elastic Memory Composite (EMC) from Composite Technology Development (CTD) company.

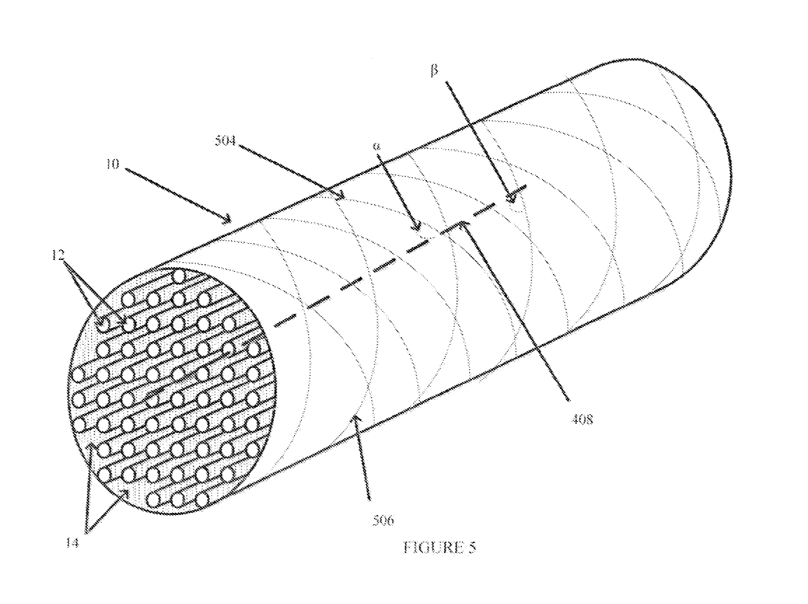

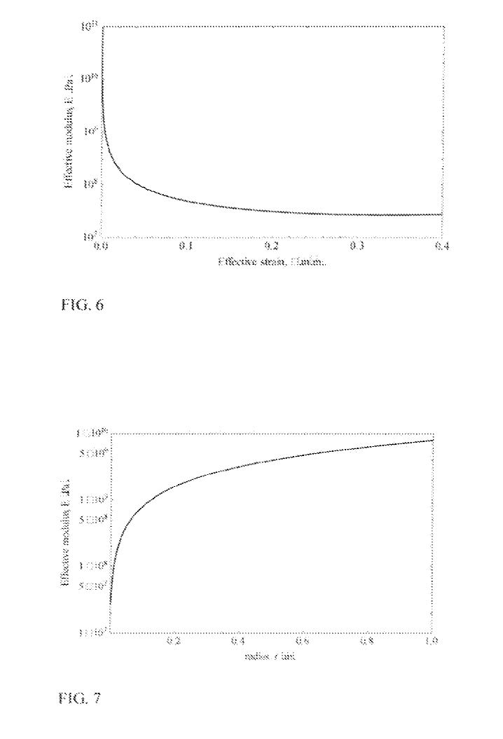

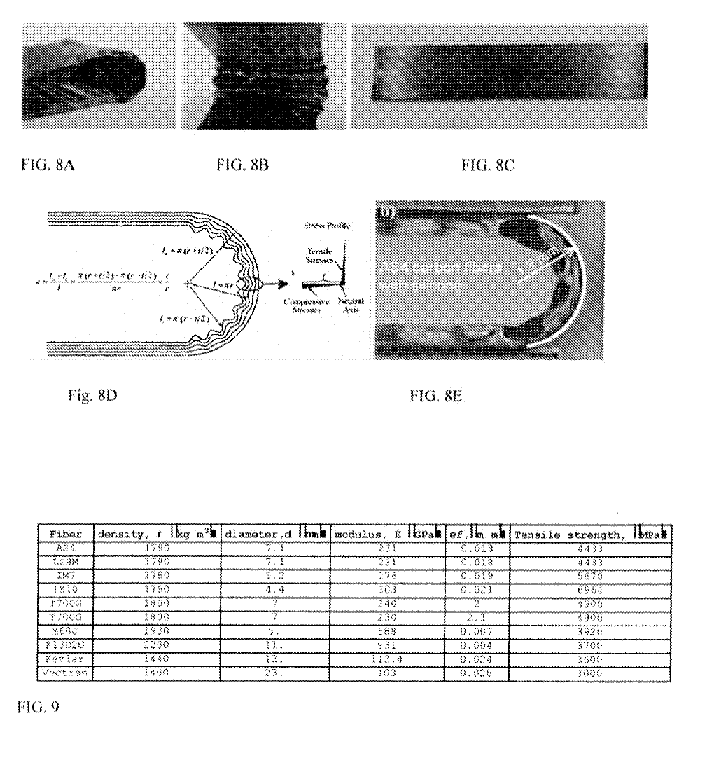

Exemplary property measurements for a thin composite application, such as that shown in FIG. 8D, are ε=64.5%, k=0.900/mm, V_{f}=35%, and t=0.54 mm.

Conventional actuated composites that present the elastic micro-buckling behavior only occur when the smart resin is heated above room temperature (between 40-80 Celsius) reducing the modulus of the resin below or above the presented resin modulus range (0.5-5 MPa). However, a resin modulus below this range will result in an elastomeric composite with non-desirable low compressive critical stresses in the deployed state causing a failure in deployable structures or some compliant mechanisms. Also, in the packaged state there will not be enough elastic property to prevent the carbon fibers to go beyond their allowed compressive strain in bending. In other words, the conventional material cannot stored strain energy. This is why actuated composites usually need to get cold to increase the smart resin stiffness and therefore increase the composite compressive properties in the deployed state. However, if the resin modulus is above the defined modulus range, then unidirectional elastomeric composites will have a kinking failure unless tension in the composite is applied as mentioned above. On the contrary, embodiments of the current composite have just enough compressive critical stress for specific deployable space structures by using resins such as silicones and polyurethanes, and can develop the elastic micro-buckling behavior when bending without the need of tension.

Exemplary fibers used herein may have ultimate elongation at failure or tensile failure strain of 1% or greater. At the same time, exemplary samples may have tensile modulus between 200-400 GPa and tensile strength greater than 4 GPa. FIG. 9 is a table that shows exemplary fibers for use herein. From this table, exemplary preferred intermediate modulus carbon fibers such as AS4, IM7, IM10, T700S and T700G, etc. meet all the above required properties at the same time. Finally, it is important to mention that to be able to obtain preferred V_{f}, fibers with sizing not greater than 1% is preferred. 0.25% sizing is ideal or any number close to 0%. 0% sizing fibers are generally very difficult to handle, while too much sizing will make it difficult to impregnate the fibers with the elastomeric resin. In addition, some resins will get poisoned with even 1% sizing. Thus, almost all elastomeric resins can stand 0.25% or 0% sizing. Usually, we can use unidirectional tow of 1-24 k filaments, however we can use any kind of carbon fabric configuration such as woven plain fabric, braided sleeve socks or tape fabrics with any amount of number of layers. It is possible to have some combination of the mentioned desired carbon fibers with any other fiber that does not meet the above specifications.

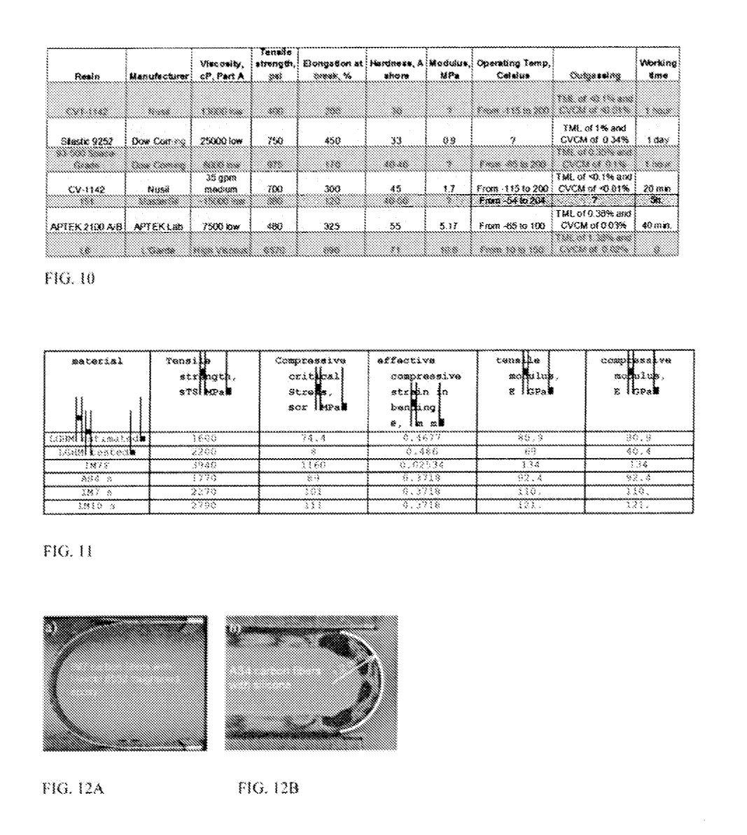

In an exemplary embodiment, the resin or matrix is a passive elastomer that will maintain its mechanical and chemical properties at a specific operational temperature range. Elastomers are polymers with viscoelasticity, generally having low Young's modulus and high failure strain compared with traditional materials such as metals, ceramics, and even epoxies and many plastics. In specific examples, after deformation, they can return their original shape. These kinds of resins may be a thermoset or thermoplastic, but the most typical ones are thermosets such as silicones and polyurethanes. Polyurethanes are easier to work with because they do not have problems with 1% sizing of the fibers, but they have a smaller operational temperature range compare with silicones. Some silicones are ideal for space applications because they have the highest operational temperature range compared with other elastomers (high and low temperatures, from −150° C. to 200° C.). Some of them can also tolerate 1% sizing in the fibers without getting poisoned. However, it is practical to use almost zero sizing to get lower V_{f}. Preferably, the resin has approximately 25-55 shore A durometer or hardness that corresponds to a Young's Modulus of 0.5-5 MPa. The best performance can be accomplished with modulus of 1-2 MPa. Some examples of elastomers are listed in FIG. 10 that meet the preferred resin requirements. Also, the resins can have elongation at break greater than 100%, tensile strength greater than 300 psi, and viscosity lower than 100,000 cP for easy impregnation. The best adhesive to use for bonding the elastomeric composites with themselves or many other materials is actually to use the same elastomer resin used in the composite or similar one with higher hardness. For example, CV-1142 can be used as the adhesive for elastomeric composites that were made with CV1-1142. The stiffer the elastomer is, the better it will be for bonding such as Aptek 2100 A/B.

A first exemplary composite material (LGHM) is made of AS4 carbon fibers, having a thickness (t=0.54 mm) and fill volume (V_{f}=35%). The tensile modulus, shear modulus and Poisson's ratio for the selected LGHM silicone are Eₘ=0.916 MPa, Gₘ=0.305 MPa, and nₘ=0.499, respectively.

Beside the estimated and tested results for LGHM, the estimated results of three alternative composite materials according to embodiments described herein are listed in FIG. 11. These alternative composite materials are unidirectional elastomeric composites (AS4/s, IM7/s, and IM10/s made with 1 MPa silicone resin) that have excellent balance of mechanical properties and material metrics compared to not only actuated composites, but also traditional materials such as IM7 carbon fibers with 8552 epoxy hard composite, IM7F (see the difference of curvature measurements of IM7F and LGHM as seen in FIGS. 12A and B). Although LGHM is thicker than IM7F, LGHM has a higher curvature before failure than IM7F.

As the alignment of the fibers may have a substantial impact on the resulting composite characteristics, manufacturing exemplary composites according to embodiments described herein may be difficult as it may be difficult to maintain the alignment and orientation of the fibers during resin application, drying, and curing. In an exemplary manufacturing process, the fibers are aligned and anchored in a desired configuration. The fibers are impregnated with a resin, such as the elastomers described herein. The application may be, for example by roller, squeegee, spray, pouring, etc. The resin/fiber is cured at a curing temperature. However, as the resins and fibers may have different coefficients of thermal expansion, the curing process may expand the resins, which introduces waves or misalignment of the fibers.

FIG. 27 illustrates an exemplary method of manufacturing unidirectional elastomeric composites as described herein. First, a plurality of fibers are provided longer than the intended length of the final composite structure. For example, fibers approximately double in length from the final intended composite structure length may be used. A mold is positioned around the fibers. The mold may comprise an inner cross sectional surface that is the same as the desired exterior surface cross sectional shape of the final composite structure. For example, a Teflon tube may be used. The mold may comprise a length equal to or greater than the desired finished length of the composite. The fibers are then placed in tension to keep the fibers straight during resin application and curing. The fibers may be put in tensions by applying one or more anchors or weights to one or more ends of the fibers. For example, as seen in FIG. 27, one end of the fibers may be anchored 2602, while opposing ends of the fibers may comprise one or more weights 2604a, 2604b. The weight may preferably comprise a rubberized or protected surface in contact with the fibers to prevent damage to the fibers. In an exemplary embodiment, approximately one pound is used per 1200 fibers to provide a generally uniform force across the plurality of fibers. The fibers may be placed under tension as a group or individually. Resin is then applied to the portion of fibers in tension outside of the mold, 2608. The mold 2608 is then translated over the portion of fibers coated by resin, 2606. The composite may then cure at room temperature over a longer period of time. Maintaining a lower temperature reduces the inconsistent expansion between fiber and resin and helps maintain the fibers straight and aligned. After the composite has cured, the mold may be removed. The mold may be cut or pulled from the composite. The mold may also be heated to expand the mold from the fiber/resin composite.

A similar process may be used to create terminal ends of the composite elastomer with different material properties. For example, if the composite elastomer is coupled to another material or structure, stronger terminal ends may be desired for such connection. To make such a segmented composite material, one or more molds may be positioned along or around the fibers. Each section may be applied with a different resin or compound to create the composite. For example, a middle portion may be made as described above to create an elastomeric composite as described herein. One or both terminal ends of the plurality of fibers extending from the applied resin portion need different material properties. Therefore a suitable epoxy or resin may be applied at the terminal ends of the resin. Different sized molds may be used at the terminal ends to create different terminal cross sectional areas. For example, larger or differently shaped molds may be used to create terminal connection ends for the composite structure. Therefore, once the resin or epoxy of one or both terminal ends is applied, then the suitable mold may be positioned over the fibers. The same or different mold may be used as that of the middle portion. The entire configuration is then left to cure as described above.

Different mold configurations may be used. The mold may positioned around the fibers before application of the resin and the fibers positioned in tension. In this case, the mold may be slid along the fibers once the resin, elastomer, or epoxy has been applied to a portion of the fibers. Alternatively, the mold may be clamped, wrapped, or otherwise positioned around the fibers after the resin, elastomer, or epoxy has been applied to the fibers in tension.

An exemplary applications of embodiments of the elastomeric composite as described herein include use as cables, cords, ropes, screens, or any member under tension. Applications may include water, space, or terrestrial, such as sports, fishing, rigging, etc. Other applications may include, for example, pneumatic muscles for prosthetics or morphing wings, tape reinforcement, high pressure inflatable structural supports, trusses, and lines (such as for bike brakes, racket strings, parachute cords, boats, guitar strings, nets, fishing, etc.).

Another application is in devices that require the stiffness to increase as a function of, like a linear spring in tension and deployable elements in deployable structures, such as deployable diagonals in deployable trusses. This could be accomplished by introducing waviness or misalignment in the carbon fibers, so when tension is applied in the elastomeric composite, the waviness or misalignments are reduced, and therefore, the stiffness in the material will increase due to the recovered straightness in the fibers.

Materials described herein may also be used, for example, in flexure hinges and compliant joints. Flexure hinges are mechanical devices that can be used not only to close and open gates, doors, windows, and laptops, but also in helping the deployment of structures and mechanical devices such as space satellites, phased arrays, morphing wings, toys, deployable trusses, etc. Flexure hinges are an excellent example of a compliant joint. For instance, flexure hinges in deployable trusses usually will uniformly curve to accommodate a 90 degree rotation. Curvatures of more or less than 90 degrees are also contemplated. For example, the hinge may accommodate curvatures of between, for example, 45 degrees to 180 degrees, or more particularly from 45 degrees to 135 degrees, or 80 to 100 degrees. The angle of hinge bending is measured from the unbent, open configuration, such that 180 degrees is folded back on itself with generally parallel ends and 90 degrees is generally positioned with the ends of the hinge perpendicularly oriented. The hinges may also flex in the mirrored direction such that a hinge may bend from −180 degrees to 180 degrees or any angle range in between. The angle may also be greater than 180 degrees such that the extended surface beyond the hinge contact along their length, while the hinge creates a smoothly curved transition section in between. The hinges may also create a compound angle such that the hinge permits the connected material to be generally parallel but brought into closer contact than in the 180 degree orientation. Accordingly, the hinge may bend beyond 180 degrees, but bend in an opposite direction at one or both opposing ends to orient the connect material beyond the hinge.

Compliant joints using embodiments described herein may use the inherent compliance of a material to be able to accomplish large deformations and reduce stress concentrations. These joints may reduce or eliminate the presence of friction, backlash, and wear. Further benefits include up to sub-micron accuracy due to their continuous monolithic construction. Such accuracy is important in many micro-, nano-, and bio-applications, as well as interdisciplinary areas such as micro- and nano-electromechanical systems. The monolithic construction also simplifies production, enabling low-cost fabrication, and low weight. Therefore, the main advantage of compliant joints is that they are used to create compliant mechanisms, such as deployable structures, morphing wings, unmanned aerial vehicles (UAVs), robots, toys, containers, etc. Additional advantages of compliant mechanisms include dramatic reduction in the total number of parts required to accomplish a specific task, significant reduction in weight over their rigid-body counterparts, and the ease in which they are miniaturized. This presents opportunities to replace complex parts of multiple materials with simplified components that deliver equivalent mechanics.

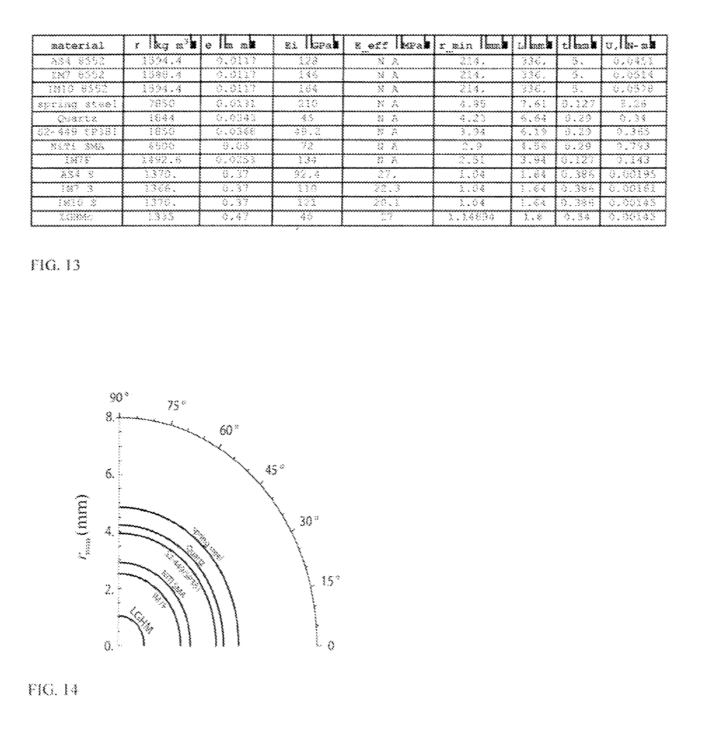

Moreover, unidirectional elastomeric composites as described herein and shown in FIGS. 13-14 are better than traditional materials for very short flexure hinges. Only, materials with moderate stiffness (40-210 GPa) were considered in FIG. 13. So polymers such as plastics and elastomers were not considered because they do not only have low stiffness, but are not dimensionally stable (high coefficient of thermal expansion CTE values) and they do not last under certain temperatures. On the other hand, NiTi superelastic Shape Memory Alloy (SMA) has excellent combination of properties, but for a narrow operational temperature range (body to room temperature). The elastomeric composites according to embodiments described herein can fold 90 degrees with the lowest stowed radius and hinge length. These passive lightweight materials have variable stiffness when they are folded that allows them to be stowed in a very tight radius and store a little strain energy like a very tiny spring. Beside the material properties detailed in this document, the filament diameter is a property to be able to store strain energy. Selected carbon fibers with bigger diameters will store more strain energy when bending the composite such as AS4, T700G, and T700S that have fiber diameters close to 7 μm compared with other medium modulus carbon fibers that have diameters close to 5 μm or less. Even though IM7/s and IM10/s have higher moduli than AS4/s, AS4 fibers have bigger diameter as shown in FIG. 9 and therefore, AS4/s has the highest stored strain energy.

Embodiments as described herein are applicable for short flexure hinges in deployable structures, as well as compliant joints in compliant mechanisms. For example, disclosed embodiments can be used to replace pin joints in compliant mechanisms, such as eyewear, robots, scissors, toys, prostheses, etc. Besides the limitations described in the background, traditional pin joints are still used today because they allow structures and mechanisms to fold in a very tight stowed volume without storing strain energy. Thus, the main reason that flexure hinges made of medium modulus materials, such as those of FIG. 13, are not used in some applications is because they cannot accomplish very small stowed radius, plus they store too much strain energy that will cause failure in structures and devices (high localized concentrated stresses). In addition, ideal materials for pin joints should have high strength and high stiffness, fatigue and stress-corrosion cracking resistance, and low density. This is not the case with current materials such as stainless steel that have high density.

In general, the composite material according to embodiments described herein represents a major improvement in compliant joints for deployable structures used in military, terrestrial and space missions. For space missions, this innovation will minimize launch mass, volume and costs, while maintaining the required structural performance in the space environment. In addition, this technology will provide a reduction in installation and labor cost not only for space systems, but terrestrial deployable mechanics that need to be portable such as deployable flying discs, car sunshades, laptops, large hats, etc.

Another area in which flexure-elastic hinges acting as compliant joints has a lot of possibilities is in vibration isolation systems such as support structures for lightweight motion devices. The effective adjustable or variable stiffness of the disclosed composite can be predetermined and calculated based on material curvature or stowed radius. Then, the ability of the material to change its stiffness will allow the system to switch its internal natural frequency away from the external forcing frequency, and therefore, will reduce the motion amplitude.

In addition, the vibration in deployable structures can be minimized by absorbing (damping) the vibrational energy of the system. Thus, instead of reducing unwanted vibrations in a structure by doing a damping treatment such as adding a layer of damping material (such as rubber) to the outside surface in order to increase the system damping, a reduction in vibration can be accomplished by replacing hard resins in composites with elastomeric resins (greater damping occurs when there is a greater mismatch between carbon fiber and resin stiffness). This approach facilitates the construction of high damping and vibration suppression components for lightweight deployable structures in general. For example, dampers and bumpers made of this material can be used to absorb impact energy or to slow down the motion of a component such as an unreeling lanyard or a deploying panel.

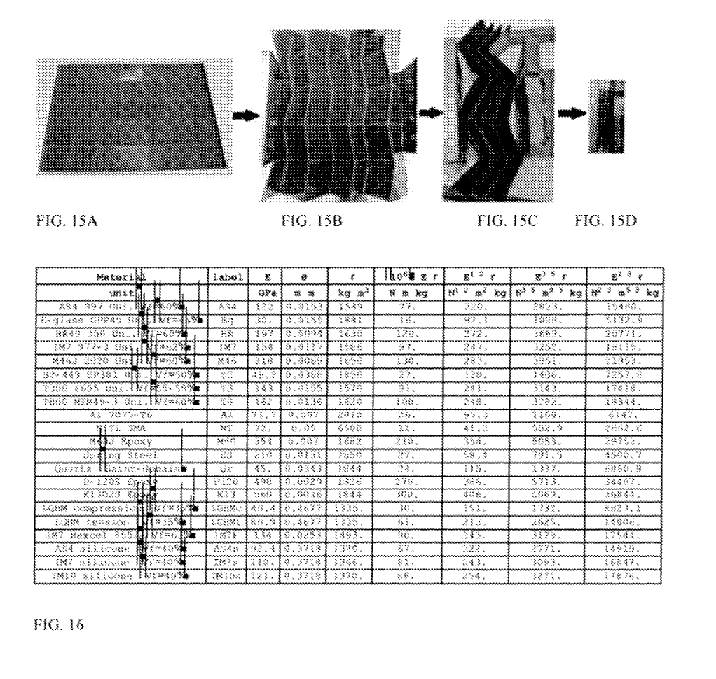

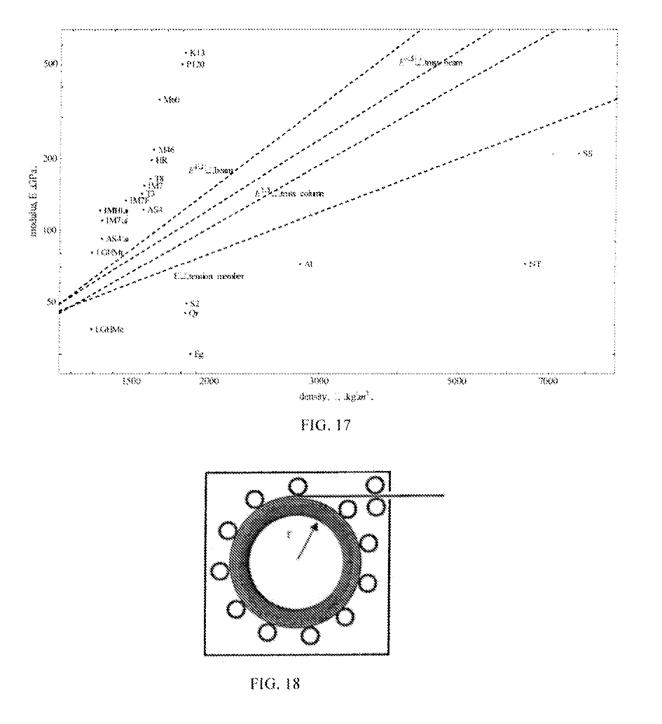

Embodiments described herein combine a high-strain resin in areas where a composite needs to fold, while maintaining a stiffer matrix in the rest of the composite. A Miura-origami composite laminas shown in FIG.15. This kind of architecture may avoid the need for fasteners or support structures since it employs a continuous uniform carbon fabric. Moreover, the novel approach of using different moduli type of resins will allow the fabrication of many kinds of compliant mechanisms such as very high efficient and lightweight deployable structures, morphing wings, robots, toys, eyewear, scissors, prostheses, unmanned aerial vehicles (UAV), etc. For instance, the current work done by other researchers in the area of deployable structures uses only paper or low modulus fibers, such as Glass-fiber, Kevlar or Vectran, in combination with a soft resin. These kinds of fibers are not stiff enough to develop good material metrics and store strain energy in the stowed configuration. The other advantage in the middle modulus carbon fibers is the higher tensile and compressive strength values compared with other fibers. Also, the gaps in which the deployable structure needs to fold are protected by the defined elastomeric resins. This will assist the avoidance of material and structural wrinkles facilitating a specific systematic folding pattern. At the same time, the proposed architectures will assist in the deployment process of the total system because they can store a little strain energy in their stowed configurations.

FIG. 15 illustrates an exemplary folding sequence of a composite lamina in a Miura-origami pattern. The folding lines are made with Fiber-Reinforced High-Strain Matrix. Deployment of an 18 in.×24 in., 0.013 in. thick Miura-origami pattern can occur in 2-3 seconds deployable time. The deployment velocity can be reduced by tailoring the material properties and geometric parameters. The approximate packaged volume is 0.5 in.×4.3 in.×3.8 in., and the weight is 94.7 g (0.209 lb).

Furthermore, the LGHMt (LGHM in tension) has a lot of potential for applications where it is required to have members in tension. Notice that in FIG. 16, LGHMt has a higher material metric, E/r, than metals and even unidirectional S2-449/SP381 (S2) composites for a member in tension. This means that elastomeric composites can be used to replace cables that need to be lightweight and in tension. In addition, for a specific type of carbon fibers, elastomeric composites and hard composites will have almost the same tensile modulus. In other words, an elastomeric composite and a hard composite with the same carbon fibers and fiber volume fraction can have almost the same material metric, E/r, value for members in tension; with the difference that the elastomeric composite will be able to develop a smaller stowed or packaging radius. For example, (V_{f}=60%) AS4/997 hard composite (AS4) in FIG. 16 has a modulus of 122 GPa and folding failure strain of 1.53%; meanwhile, for (V_{f}=63%) AS4/silicone elastomeric composite (AS4/s), a tensile modulus and folding failure strain of 92 GPa and 37% is predicted, respectively. This preliminary observation can lead to another application for tensioned lightweight deployable structures. For instance, the embodiments described herein will be a better choice compared with hard composites because this application requires a thin tensioned structure in the deployed state; whereas in the packaged state the substrate material will not be in tension, but instead needs to be able to roll up as shown in FIG. 18. Therefore, for tensioned thin composites that need to package into a small volume and be stiff in the deployable configuration, it is recommended to use embodiments herein independent of whether the compressive critical stress is low. One important application will be to replace current strings use in music instruments such as guitars, pianos, violin, etc. Speakers made from the inventive material are also possible. In sports such as archery and fishing, strings and line can be made from embodiments described herein.

There is also the possibility to reduce weight by embedding for the first time electrical cables inside the novel composites instead of having two separate components. For instance, solar array panels typically have to have hinges next to flat cables. It is possible to incorporate electrical cables internal to embodiments describe herein.

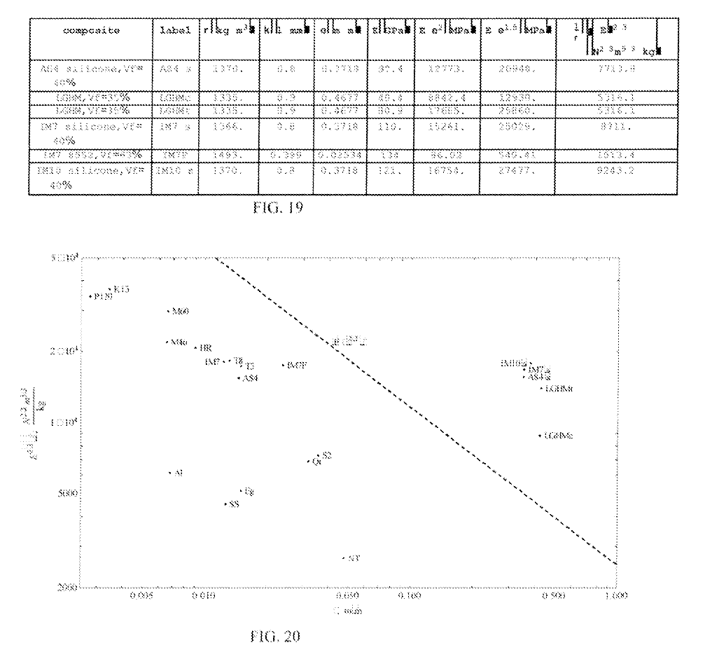

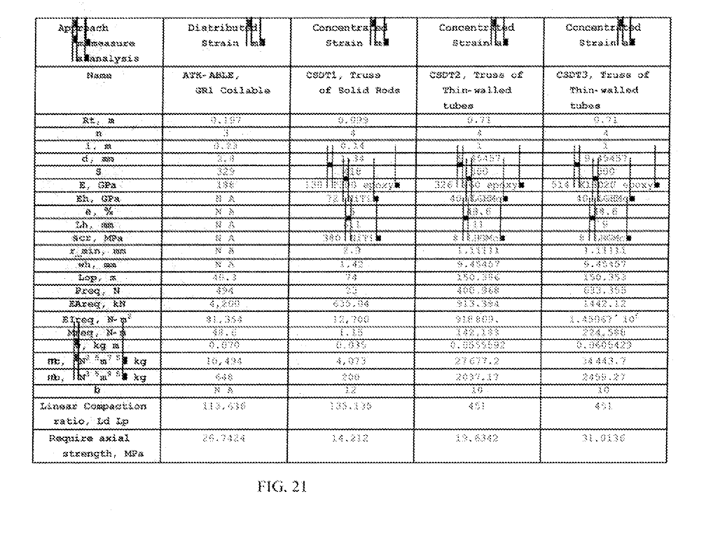

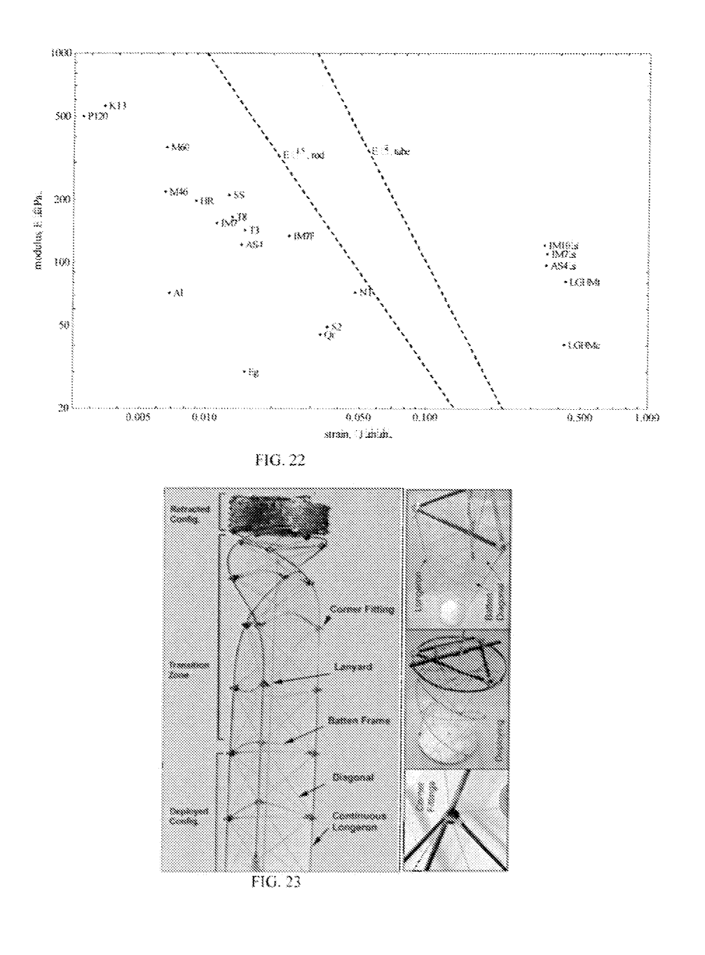

Embodiments of the material disclosed herein have better material metrics than hard composites, and store very little energy to facilitate and safely deploy hierarchical architectures. For example, the material metric for a distributed strain deployable truss like a coilable truss is p⁻¹(ε E)^{2/3}. For the innovate composite, this material metric is estimated as high as 9,243 N^{2/3} m^{5/3}/kg compared to 1,513 N^{2/3} m^{5/3}/kg for unidirectional hard composites as shown in FIGS. 19 and 20. This means that by using the new material, distributed strain deployable trusses can be manufactured with a conical cross section that can either be conical folded or roll up folded. Notice that the material with the highest material metrics is IM10/s because the IM10 carbon fibers have the highest mechanical properties compared to other fibers. IM10 carbon fibers have a bending strain failure of 2.1%, a tensile strength of 1010 ksi (6964 MPa) and a modulus of 44 Msi (303 GPa). However, AS4/s will guarantee the highest spring stored effect due to higher strain stored energy.

In addition, the disclosed material not only has better material metrics than unidirectional hard composites for trusses using the distributed strain approach, but also for deployable trusses using the concentrated strain approach as shown in FIGS. 19-20. Note that the concentrated strain approach requires only very short flexure hinges. As shown in FIG. 21, a concentrated strain deployable truss made of very stiff thin-walled longeron tubes comprising composites as described herein may have almost three times higher truss performance indices than the best distributed strain deployable truss such as ATK-Able Graphite Coilable Truss, FIG. 23. The trusses in FIG. 23 were compared with two conceptual concentrated strain deployable trusses of thin-walled tubes, FIG. 21. These conceptual trusses have better truss performance indices with similar mass per length than the coilable truss.

Embodiments described herein can be used to improve bending actuators such as piezo-electric actuators when they are used as the subtracted material. The new advanced piezoelectric actuator will be lightweight and will have larger curvature enhancing the performance in research areas such as control flow, morphing wings, membrane actuated shape, optically actuated surface, artificial muscles, skin adaptive systems, non-explosive release devices, etc. The main reason is that piezo-electric materials are attached to passive substrate materials that, when actuated, bend without a change in the neutral axis position along half the substrate material thickness. Thus, the lack of a neutral axis change makes traditional substrate materials less energy efficient and less flexible unless they use polymers such as plastics and elastomers. However, as seen in FIG. 8, when bending a composite as described herein, the fibers in most of the layers will buckle and store strain energy since the neutral axis shifts closer to the outer surface layer. Since the closer the fibers are to the inner layer the more they buckle. The opposite happens with the fibers that are closer to the outer surface layer. These are in tension and are attached to the piezo-electric material. This will allow large deformations and minimum stowed radius, not possible with traditional piezo-electric actuators.

In addition, solid rods or tubes can be made with the above fibers and resin description using a Teflon tube and/or Teflon rods. Solid rods as small as 1 mm diameter can be fabricated with any amount of fiber tows. The main application for solid rods and tubes ocycle almost any size made of unidirectional elastomeric composites is to replace torsional springs or torsional rods in compliant mechanisms such as scissors, bicycle breaks, clips, laptops, doors, lightweight torsional bar suspension, eyewear and window torsional pins. The composite material can be a flexure lightweight torsional spring that can rotate up from 0 to 360 degrees or less. It is also possible to fabricate conical solid rods.

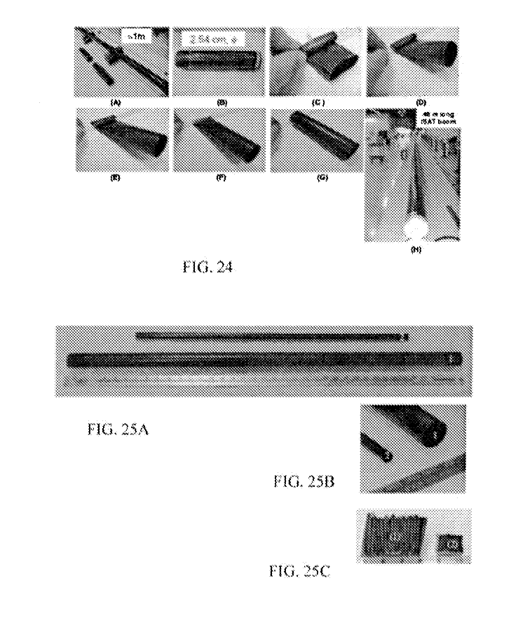

Also, by using braided sleeve fibers of any material, angle orientation and any amount of layers, it is possible to make tubes of many sizes that can be use for not only hinges, booms, pen, cylinders, tires, space habitat and tanks, but collapsible tubes as shown in FIGS. 24 and 25. The booms made under this effort were composed of braided sleeve carbon fibers and silicone (FIG. 24A-FIG. 24G) and urethane (FIG. 24H and FIG. 25).

Another application will be for grips in general such as pen grips, kitchen grips, and bike grips. If a solvent is added inside the tubes, they can contract and increase diameter making them act as actuator for applications such as parachutes, artificial muscles, morphing wings, etc.

Any combination of the above mentioned flat samples, with solid rods and/or tubes can be used to develop advanced compliant joints, compliant mechanisms and deployable structures that require more than two connections at the same joint. In addition, composite materials described herein can be used for making book and notebook covers as well as roofing, carpets, bracelets and straps. If different color fibers are used such ask kevlar, vectran, fiber glass and carbon fiber, then illustrations, drawings, text, images, colors, etc. can be created in the products.

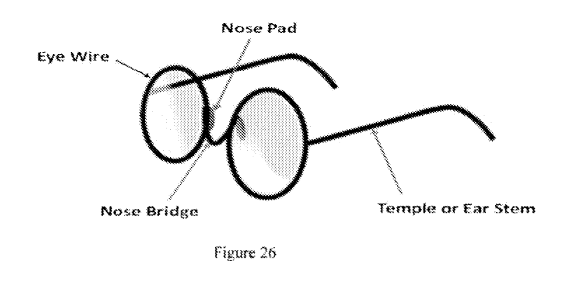

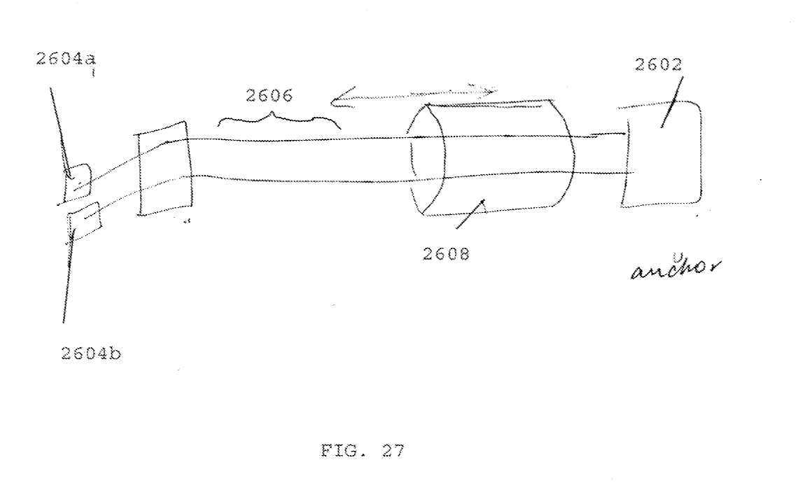

The following are various design methods for manufacturing eyewear frames using material and hinge embodiments described herein. For sake of clarity, the following terms will be used to describe the various components of frames as shown in FIG. 26.

There are typically two hinges located at the junction of the temples and the eye wires that permit the folding of the temples generally parallel to the frontal frame. These hinges consist of two metal bodies which mesh together like the hinges on a door. A small screw through the interlock mechanism keeps the two parts from separating while allowing movement for folding and unfolding.

The composite material described herein can be used to replace both of these conventional “post” hinges. A small segment of composite material would be fastened to the eye wire and the temple, permanently connecting them. This could be done using an adhesive, welding, pressing or any other attachment technique. The composite material is designed to allow the temples to be folded against the frontal frame section and unfolded to a certain limit (approximately 90°) to fit snugly against the wearer's head.

Most eyewear contains small springs in the temples, near the hinge connecting the temple to the eye wire, that allow some limited elastic movement of the temples beyond their normal range when unfolded. These springs supply some retaining force to push the temple gently against the wearer's head, maintaining the eyewear snuggly on the head of the wearer. These springs can be replaced by the FLASH in one of two ways: (i) two separate sections of composite material can be used to replace the primary hinge and the spring, or (ii) a single piece of composite material can be used to both allow the folding and unfolding of the temple as well as to supply the snugging force to push the temple against the head.

Some eyewear contains multiple post hinges employing screws that allow the eyewear to be folded into an even more compact form factor. In addition to the two hinges connecting the temples to the eye wires, there are hinges in the middle of each temple and one or two hinges on the nose bridge that allow the eyewear to fold into a tighter form, slightly larger than the size of one eye wire. All or some of these hinges can be replaced by composite material segments.

In some embodiments, it may be desirable to construct entire components of the eyewear frame out of composite material. Thus, the temples, the nose bridge, the eye wires or any combinations of these may be comprised entirely or nearly entirely from the composite material described herein.

The composite material segments used to replace the hinges and springs have a normal “zero energy” position (as in an unstretched spring) as well as a “stored energy” position (“stretched”); the composite material can naturally have a desire to return to its zero energy position. In all of the above embodiments using composite materials disclosed herein, the zero energy position can be either the folded configuration or the unfolded configuration. Thus, for #1 above, the eyewear can be constructed such that, when the eyewear is free to move, the composite material can be designed and manufactured to naturally return to either the folded position for storage or the unfolded position for wearing.

As used herein, the following symbols and nomenclature is used:
A=cross-section area, m²
I=area moment of inertia, 1/m⁴
ε=effective compressive strain in bending or hinge strain
ε_{f}=ultimate elongation at failure or failure strain of fibers
ε_{b}=bending strain of carbon fibers
E=Young's modulus or effective compressive stiffness, GPa
E_{eff}=Effective compressive strain in bending, Pa
[symbol] =strain stored energy, N-m
r=stowed radius, mm
κ=curvature, 1/mm
S=slenderness
ρ=density, kg/m³
σ_{σ}=compressive critical stress, Pa
σ_{TS}=tensile strength, Pa
V_{f}=fiber volume fraction
L=hinge length or longeron length, mm
Lₜₚ=optimal length of truss, mm
Lₚ=packaged length, m
L_{d}=deployed length, m
[symbol] =number of truss bays between longeron hinges
M=bending moment, N-m
[symbol] =hinge width, longeron diameter, or truss mass per length, mm, kg/m
[symbol] =thickness of material, mm
[symbol] =fiber diameter, mm
[symbol] =truss performance index in compression, (N^{2/5} m^{7/5})/kg
[symbol] =truss performance index in bending, (N^{3/5} m^{9/5})/kg
Rₜ=truss radius, m

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims.

The invention claimed is:

1. An elastomeric composite, comprising:
a plurality of fibers generally aligned with each other;
an elastomer filling a space between the plurality of fibers.

2. The elastomeric composite of claim 1, wherein the fiber volume fraction, V_{f}, is between approximately 35 and 65%.

3. The elastomeric composite of claim 1,wherein the density of the unidirectional elastomeric composite is between 600 to 1350 kg/m³.

4. The elastomeric composite of claim 1, wherein an initial tensile modulus in a deployed state of the elastomeric composite, when fibers are straight, are between 30-150 GPa.

5. The elastomeric composite of claim 1, further comprising a layer of kapton on at least one exterior surface of the elastomeric composite to control a minimum allowed stowed radius.

6. The elastomeric composite of claim 1, further comprising a layer of mylar on at least one exterior surface of the elastomeric composite to control a minimum allowed stowed radius.

7. The elastomeric composite of claim 1, further comprising a woven carbon fabric aligned oblique with a longitudinal axis of the plurality of fibers.

8. The elastomeric composite of claim 1, further comprising a second plurality of fibers generally aligned with each other creating an exterior layer on an exterior edge of the elastomeric composite, the second plurality of fibers angled oblique with the first plurality of fibers.

9. The elastomeric composite of claim 8, wherein the second plurality of fibers angled about 45 degrees with respect to the first plurality of fibers.

10. The elastomeric composite of claim 1, wherein the first plurality of fibers have an ultimate elongation at failure or tensile failure strain of 1% or greater.

11. The elastomeric composite of claim 1, wherein the first plurality of fibers have a tensile modulus between 200-400 GPa and tensile strength greater than 4 GPa.

12. The elastomeric composite of claim 1, wherein the first plurality of fibers comprise an intermediate modulus carbon fibers.

13. The elastomeric composite of claim 12, wherein the wherein the elastomeric composite has a passive deployment mechanism that allows the intermediate modulus carbon fibers to micro-buckle out-of-plane, preventing them from breaking when the composite is folded.

14. The elastomeric composite of claim 1, wherein the elastomer is a passive elastomer that maintains its mechanical and chemical properties over a specific operational temperature range.

15. The elastomeric composite of claim 14, wherein the operational temperature is between −150° C. to 200° C.

16. The elastomeric composite of claim 1, wherein the elastomer has approximately 25-55 shore A durometer.

17. The elastomeric composite of claim 1, wherein the elastomer has a Young's Modulus of 1-2 MPa.

18. The elastomeric composite of claim 1, wherein the elastomer has a tensile strength greater than 300 psi.

19. A unidirectional elastomeric composite comprising a plurality of carbon fibers and silicone, wherein the carbon fibers have a fill volume of approximately 35-65% compared to the entire volume of the unidirectional elastomeric composite.

20. A method of manufacturing an elastomeric composite, comprising:
providing a plurality of unidirectional fibers;
placing the plurality of unidirectional fibers under tension;
applying an elastomer while the plurality of unidirectional fibers are in tension;
curing the elastomer and plurality of unidirectional fibers within a mold;
removing the mold to form a unidirectional elastomeric fiber composite.
